(19) United States
(12) Patent Application Publication
(10) Pub. No.: US 2004/0179687 A1
(43) Pub. Date: Sep. 16, 2004

(54) METHOD FOR TRANSMITTING COPYRIGHTED ELECTRONIC DOCUMENTS IN A WIRELESS COMMUNICATION SYSTEM

(76) Inventors: Cheng-Shing Lai, Taipei Hsien (TW); Lin Zhang, Nanjing (CN); Shuang-Jun Xu, Nanjing (CN)

Correspondence Address: NAIPO (NORTH AMERICA INTERNATIONAL PATENT OFFICE), P.O. BOX 506, MERRIFIELD, VA, 22116, US

(21) Appl. No.: 10/249,078

(22) Filed: Mar. 14, 2003

(51) Int. Cl. G06F 11/30

(52) U.S. Cl. 380/247

(57) ABSTRACT

A method for transmitting a copyrighted electronic document in a wireless communication system is disclosed. The wireless communication system has an electronic document management server and at least a base station, where the wireless communication system can utilize the base station to wirelessly transmit data to at least a mobile phone. The method includes a registration procedure for providing certification information to the mobile phone and a downloading procedure for transmitting an encrypted document to the mobile phone so that the mobile phone can use the certification information to decrypt the encrypted document into the electronic document.

### BACKGROUND OF INVENTION

1. Field of the Invention

The present invention relates to a method for transmitting an electronic document in a wireless communication system, and more particularly, to a method for transmitting a copyrighted electronic document in the wireless communication system.

2. Description of the Prior Art

Widely available mobile communications is one of the distinctive hallmarks of modern information-based society. Not long ago, mobile phones were too expensive for the average consumer to afford. Mobile phone coverage was limited and of poor quality. Service was either nonexistent outside of major metropolitan areas or at least unreliable. Primary users of mobile phones were large companies employing field staff and individuals who could afford the added expense and needed to make phone calls while on the go. However, it was expected that someday most people would own and use a mobile phone, and it was simply a matter of time before the technology matured and the infrastructure was built to make personal mobile communications affordable.

Currently, the mobile communications industry is growing rapidly. Many individuals-now own mobile phones, as the cost of one has become comparable to the cost of traditional landline telephone service. In fact, many people spend more time talking on their mobile phones than they do talking on their home phones. Mobile phones are a key element in modern business communications. Parents use them to keep in touch with their children. People in emergencies can use them to call for help. Additionally, with the development of hand held computers also comes the desire to be able to transfer data, such as information from the Internet, through the mobile phone communications system. Clearly, mobile phones have transformed the way people live.

On the other hand, with the rapid development of mobile phones, people have become accustomed to utilizing mobile phones to receive information. Traditionally, knowledge has been disseminated by way of the printed word in books, newspapers, or magazines. With the advent of radio and TV broadcasting, the spread of information increased dramatically. The development of computer communications and the Internet, presently, enables knowledge and information to be transmitted all over the world at a surprising speed. The development of the Internet has generated many new commercial methods; these new methods have the common characteristic of utilizing the Internet for transaction purposes, which is commonly called electronic commerce. Although it is easy to purchase electronic documents by way of electronic commerce, it is not easy to ensure security for such electronic documents.

As indicated above, the concept of an electronic reading device has been provided for the requirements of digitized written words and patterns in books to form electronic books. A consumer can purchase electronic books or documents through a network and download the electronic books to a mobile phone that the consumer owns, by connecting the mobile phone to the network. The mobile phone, thus, can be called the electronic reading device. Although it is a simple and practical concept to utilize the mobile phone to purchase and download the desired electronic books or documents, it is also simple to encounter the problem in which a consumer purchases and reads an electronic book in a legal way, and then transmits or spreads the electronic book to others in an illegal way. The need to consider the requirements of copyright must be considered in the design for a transmitting procedure of electronic documents.

### SUMMARY OF INVENTION

It is therefore a primary objective of the claimed invention to provide a method for transmitting copyrighted electronic documents in a wireless communication system.

The wireless communication system has an electronic document management server and at least a base station. The electronic document management server can utilize the base station to wirelessly transmit data to at least a mobile phone. The method comprises a registration procedure and a downloading procedure. The registration procedure comprises:

(a)the electronic document management server determining whether to authorize the mobile phone to download the electronic document from the electronic document management server according to registration information of the mobile phone; and

(b)the electronic document management server wirelessly transmitting certification information to the mobile phone via the base station.

The downloading procedure comprises:

(c)the mobile phone transmitting a downloading request to the electronic document management server for downloading the electronic document;

(d)the electronic document management server encrypting the electronic document into a ciphered document according to the downloading request, and wirelessly transmitting the ciphered document to the mobile phone via the base station;

(e)the mobile phone receiving the ciphered document from the base station; and

(f)the mobile phone utilizing the certification information to decrypt the ciphered document into the electronic document.

Because the electronic document is encrypted into the ciphered document before being transmitted to a specific mobile phone and the mobile phone needs the certification information to decrypt the ciphered document into the electronic document, even if the ciphered document is spread illegally, the ciphered document cannot be decrypted into the electronic document successfully without the correct certification information received from the electronic document management server. The copyrighted electronic document, thus, is under a proper protection from illegal distribution.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a wireless communication system according to the present invention.

FIG. 2 is a flowchart of a registration procedure according to the present invention.

FIG. 3 is a flowchart of a downloading procedure according the present invention.

FIG. 4 is a flowchart of a procedure used when a mobile phone attempts to attach an electronic document to an email.

FIG. 5 is a flowchart of a procedure used when a mobile phone attempts to transmit an electronic document to a personal computer.

### DETAILED DESCRIPTION

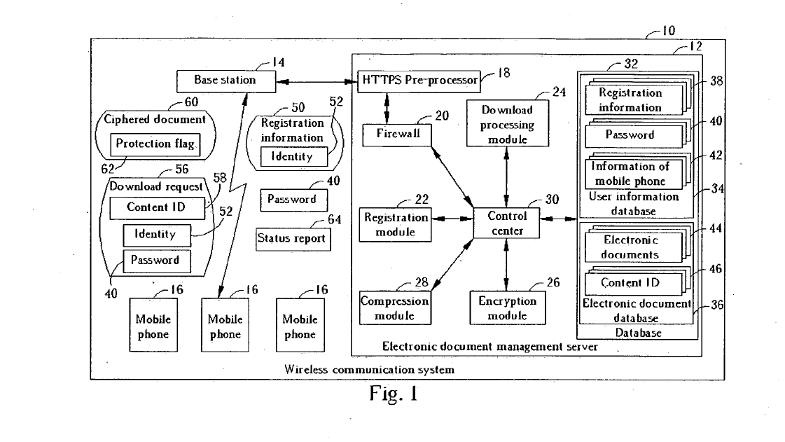

Please refer to FIG. 1, which is a functional block diagram of a wireless communication system 10 according to the present invention. The wireless communication system 10 comprises an electronic document management server 12, a base station 14, and a plurality of user clients 16, i.e. mobile phones. The electronic document management server 12 provides electronic document service in the wireless communication system 10 and enables users of the mobile phones 16 to purchase a desired electronic document, electronic book, electronic news, or other electronic information. Wireless communication connections are established between the base station 14 and the mobile phones 16 so that the electronic document management server 12 and the mobile phones 16 are capable of transmitting data to each other via the base station 14. The electronic document management server 12 connects to the Internet, and the users of the mobile phones 16 can use specific devices, such as personal computers, to communicate with the electronic document management server 12. Moreover, in the embodiment, the mobile phones 16 are compatible with WAP(Wireless Application Protocol) or GPRS (General Packet Radio Service) systems and are capable of communicating with other devices via the Internet.

The electronic document management server 12 comprises an HTTPS pre-processor 18, a firewall 20, a registration module 22, a download processing module 24, an encryption module 26, a compression module 28, a control center 30, and a database 32. Transaction security in the wireless communication system 10 is an important topic. For the time being, data transmission on the wireless communication system 10 utilizes encryption, and HTTPS is the major protocol for encrypted transmission. The HTTPS pre-processor 18 is used to perform an initial decryption procedure before the HTTPS encryption data enters into the electronic document management server 12. The firewall 20 filters packages from the HTTPS pre-processor 18, allows certain registered internet services like telnet, e-mail, or FTP to connect to the control center 30, and ensures both the configuration and information of the electronic document management server 12 are not compromised, i.e., hacked. The registration module 22 registers a mobile phone 16 assigned by a user so that the user becomes a legal registered user and the assigned mobile phone 16 also becomes a legal terminal that may download electronic documents 44 in a legal manner.

The download processing module 24 is used to perform procedures related to when a user downloads a desired electronic document 44 and to verify and confirm the download requests from the user. The encryption module 26 is used to encrypt the plaintext of an electronic document 44, which can be later sent to the mobile phone 16 of the user after completion of the process of verifying and confirming the download requests. The compression engine 28 performs a compression procedure to documents or data downloaded by the user so as to reduce transmission bandwidth of the data, and thus shorten the transmission time. The database 32-comprises at least two sub databases, i.e. a user information database 34 and an electronic document database 36. The user information database 34 stores registration information 38, corresponding passwords 40, and fundamental information of assigned mobile phones 42, such as the serial number or the IMEI (International Mobile Equipment Identity) of the mobile phone 16. The electronic document database 36 stores the plaintext of the electronic documents 44, and corresponding content IDs 46. Each content ID 46 enables the database 32 to perform a cross-checking and filing process for an electronic book or electronic document 44. The control center 30 is used to control operations of the electronic document management server 12, and to process each module, device or database of the electronic document management server 12.

The method for transmitting copyrighted electronic documents 44 in the wireless communication system 10 comprises a registration procedure and a downloading procedure, which are discussed in detail below. [0028] The objective of the registration procedure is to enable a user to become a legal user by registering with the electronic document management server 12. In addition, the registration procedure also enables a mobile phone 16 of the user, used to download the electronic documents 44, to become a legal terminal. In the registration procedure, a user can use not only the mobile phone 16 but also other device, such as a personal computer, to connect to the electronic document management server 12 to download an application form for authorization by the electronic document management server 12 of a legal user and a legal terminal. After filling out the application form, registration information 50 for authorization is transmitted through the base station 14 to the electronic document management server 12. Then, the electronic document management server 12 deals with the authorization request according to the registration information 50 to determine whether to authorize the mobile phone 16 assigned by the user as a legal terminal for downloading the electronic documents 44 from the server 12. The registration information 50 comprises the user name and an identity 52. The identity 52 can be the IMEI or the IMSI (International Mobile Subscriber Identity) that is used by the server 12 to determine whether to authorize the mobile phone 16 to become a legal terminal for downloading the electronic document 44. After the authorization of the mobile phone 16, the control center 30 inserts a row of data into the user information database 34 according to the registration information 50 received from the mobile phone 16. The new row inserted into the user information database 34 comprises corresponding registration information 38, a corresponding password 40, and specific information of the mobile phone 42. After the insertion of the new row into the user information database 34, the password 40 is encrypted and then transmitted to the mobile phone 16 assigned by the legal user. Therefore, the mobile phone 16 can use the received password 40 to request authorization for downloading the electric documents 44 from the electronic document management server 12. The password 40, thus, is taken as certification information of the mobile phone 16, which is used by the server 12 to determine whether or not to authorize the mobile phone 16 to download the electric documents 44. After the mobile phone 16 receives the password 40 from the server 12, the mobile phone 16 feedbacks the password 40 and transmits the identity 52 again to the electronic document management server 12, and then the electronic document management server 12 compares the fed-back data with the data stored in the user information database 34 to ensure the accuracy of the data stored in the user information database 34.

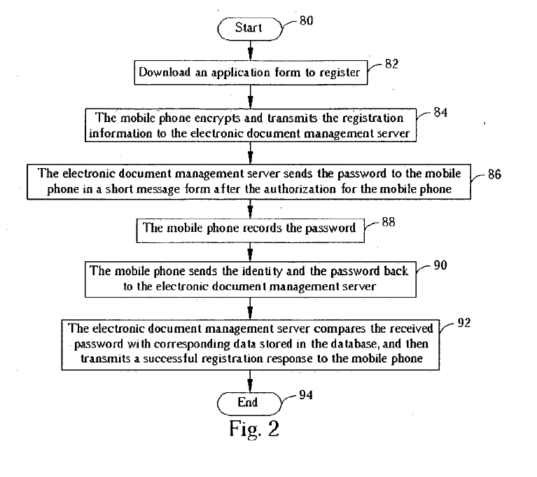

Please refer to FIG. 2, which is a flowchart of the registration procedure according to the-present invention. The registration procedure comprises the following steps:

Step 80:Start;

Step 82:The user controls the mobile phone 16 to download the application form from the electronic document management server 12 to register;

Step 84:The mobile phone 16 encrypts and transmits the registration information 50, i.e. including the identity 52, to the electronic document management server 12;

Step 86:The electronic document management server 12 sends the password 40 to the mobile phone 16 in a short message form after the authorization for the mobile phone 16;

Step 88:The mobile phone 16 records the password 40;

Step 90:The mobile phone 16 sends the identity 52 and the password 40 back to the electronic document management server 12;

Step 92:The electronic document management server 12 compares the received password 40 with corresponding data stored in the database 32, and then transmits a successful registration response to the mobile phone 16; and

Step 94: End.

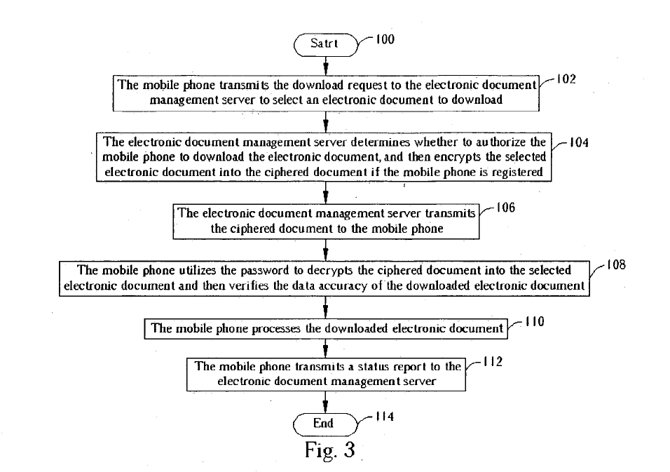

After finishing the registration procedure, the user of the mobile phone 16 can download the electronic documents 44 from the server 12 by following the downloading procedure. The user controls the mobile phone 16 to connect to the electronic document management server 12 and then selects a desired document 44 to download. When the, document 44 is selected, the mobile phone 16 sends a download request 56 to the electronic document management server 12 to request the electronic document management server 12 to transmit the selected document 44 to the mobile phone 16. The download request 56 comprises the password 40 and a content ID 58 of the selected document 44. The electronic document management server 12 retrieves the selected document 44 by comparing the content ID 58 with the content IDs 46, and determines whether the mobile phone 16 has been authorized to download the selected electronic document 44 according to the identity 52 and the password 40. If the identity 52 or the password 40 provided by the mobile phone 16 does not match the registration information 32 stored in the user information database 34, the electronic document management server 12 refuses to transmit the selected electronic document 44 to the mobile phone 16 and terminates the connection with the mobile phone 16. If the identity 52 and the password 40 match the registration information 32 stored in the user information database 34, the electronic document management server 12 authorizes the mobile phone 16 to download the selected electronic document 44. Before the electronic document management server 12 transmits the selected electronic document 44 to the mobile phone 16, the electronic document management server 12 encrypts the selected document 44 into a ciphered document 60 and inserts a protection flag into the ciphered document 60 to restrict the mobile phone 16 from transmitting the ciphered document 60 or the selected electronic document 44 to any non-authorized device. When the mobile phone 16 receives the ciphered document 60, the mobile phone 16 utilizes the password 40, i.e. certification information received from the electronic document management server 12, to decrypt the ciphered document 60 into the selected electronic document 44. However, if the password 40 is incorrect, the mobile phone 16 cannot decrypt the ciphered document 60 into the electronic document 44. Please refer to FIG. 3, which is a flowchart of the downloading procedure according the present invention. The downloading procedure comprises:

Step 100: Start;

Step 102:The mobile phone 16 transmits the download request 56 to the electronic document management server 12 to select an electronic document 44 to download, where the download request 56 comprises the content ID 58, the identity 52, the password 40, etc;

Step 104:The electronic document management server 12 determines whether to authorize the mobile phone 16 to download the electronic document 44. If the mobile phone 16 is registered, the electronic document management server 12 encrypts the selected electronic document 44 into the ciphered document 60 and inserts the protection flag 62 into the ciphered document 60;

Step 106:The electronic document management server 12 transmits the ciphered document 60 to the mobile phone 16;

Step 108:The mobile phone 16 utilizes the password 40 to decrypts the ciphered document 60 into the selected electronic document 44, and then the mobile phone 16 verifies the data accuracy of the downloaded electronic document 44;

Step 110:The mobile phone 16 processes the downloaded electronic document 44 by, for example, displaying the downloaded electronic document 44 on a screen;

Step 112:The mobile phone 16 transmits a status report 64 to the electronic document management server 12, and the electronic document management server 12 stores the status report 64 in the database 32; and

Step 114: End.

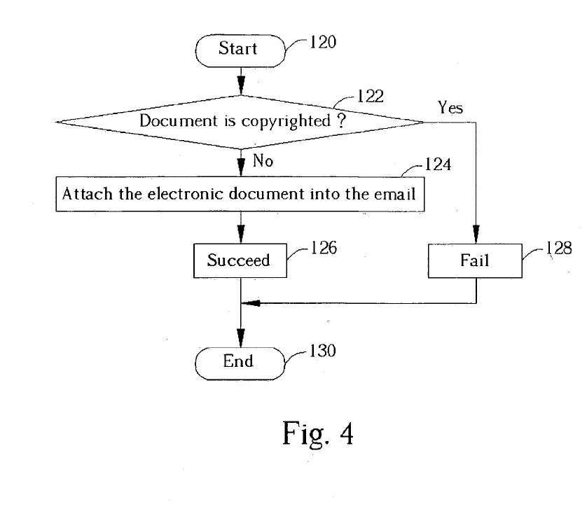

Please refer to FIG. 4, which is a flowchart of a procedure used when the mobile phone 16 attempts to attach the electronic document 44 to an email. Before the mobile phone 16 attempts to attach the electronic document 44 to the email to send the electronic document 44 to another device (step 120), the mobile phone 16 checks whether the electronic document 44 comprises the protection flag 62 so as to determine whether the electronic document 44 is copyrighted (step 122). If the electronic document 44 comprises the protection flag 62, it means that the electronic document 44 is copyrighted and cannot be transmitted to any non-authorized device so that the action to attach the electronic document 44 will fail (steps 128 and 130). However, if the electronic document 44 does not comprise the protection flag 62, it means that the electronic document 44 is non-copyrighted and can be transmitted to other devices so that the action to attach the electronic document 44 will succeed (steps 124, 126, and 130).

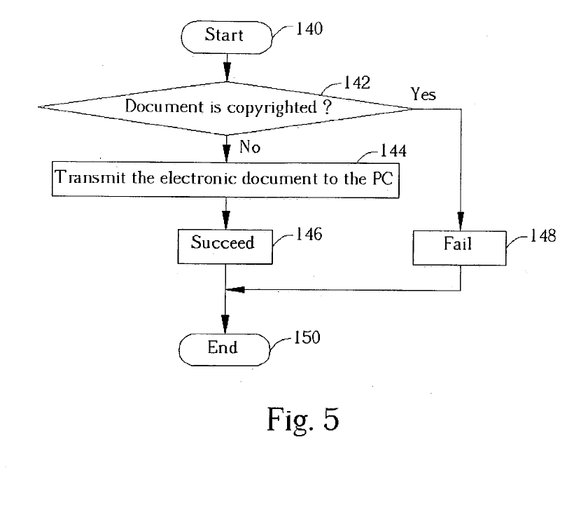

Please refer to FIG. 5, which is a flowchart of a procedure used when the mobile phone 16 attempts to transmit the electronic document 44 to a personal computer (PC). Before the mobile phone 16 attempts to transmit the electronic document 44 to the PC (step 140), the mobile phone 16 checks whether the electronic document 44 comprises the protection flag 62 to determine whether the electronic document 44 is copyrighted (step 142). If the electronic document 44 comprises the protection flag 62, it means that the electronic document 44 is copyrighted and cannot be transmitted to any non-authorized device so that the action to transmit the electronic document 44 will fail (steps 148 and 150). However, if the electronic document 44 does not comprise the protection flag 62, it means that the electronic document 44 is non-copyrighted and can be transmitted to other devices so that the action to transmit the electronic document 44 will succeed (steps 144, 146, and 150). Therefore, the copyrighted electronic document 44 is protected from illegal transmission to non-authorized devices.

In contrast to prior art methods of document distribution that are unable to protect copyrighted electronic documents from illegal distribution, the present invention provides a method to protect copyrighted electronic documents from illegal distribution. Therefore, while customers can still enjoy the convenience of electronic documents, the publishers of the electronic documents have proper protection for their electronic publications.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for transmitting a copyrighted electronic document in a wireless communication system, the wireless communication system comprising an electronic document management server and at least a base station, wherein the electronic document management server can utilize the base station to wirelessly transmit data to at least a mobile phone, the method comprising a registration procedure and a downloading procedure, the registration procedure comprising:
(a) the electronic document management server determining whether to authorize the mobile phone to download the electronic document from the electronic document management server according to registration information of the mobile phone; and
(b) the electronic document management server wirelessly transmitting certification information to the mobile phone via the base station;
the downloading procedure comprising:
(c) the mobile phone transmitting a downloading request to the electronic document management server for downloading the electronic document;
(d) the electronic document management server encrypting the electronic document into a ciphered document according to the downloading request, and wirelessly transmitting the ciphered document to the mobile phone via the base station;
(e) the mobile phone receiving the ciphered document from the base station; and
(f) the mobile phone utilizing the certification information to decrypt the ciphered document into the electronic document.

2. The method of claim 1 wherein the electronic document management server comprises a database for storing data, the registration information is stored in the database in step (a), the mobile phone inserts the registration information into the downloading request in step (c), and the electronic document management server determines whether the registration information of the downloading request is the same as the registration information stored in the database in step (d).

3. The method of claim 1 further comprising:
(g) the mobile phone transmitting a status report to the electronic document management server after decrypting the ciphered document into the electronic document.

4. The method of claim 1 wherein the electronic document management server inserts a protection flag into the ciphered document in step (d) so that the mobile phone is unable to transmit the ciphered document or the electronic document to any non-authorized device.

5. The method of claim 1 wherein the electronic document is an electronic book, electronic news, or electronic information.
